(19) United States
(12) Patent Application Publication
(10) Pub. No.: US 2008/0018574 A1
(43) Pub. Date: Jan. 24, 2008

(54) Drive circuit having plural output amplifiers for driving display cells with delay minimized

(75) Inventors: Takehiro Takayanagi, Ibaraki (JP); Takeshi Nosaka, Ibaraki (JP)

Correspondence Address: NIXON PEABODY, LLP, 401 9TH STREET, NW, SUITE 900, WASHINGTON, DC, 20004-2128, US

(73) Assignee: OKI ELECTRIC INDUSTRY CO., LTD.

(21) Appl. No.: 11/826,557

(22) Filed: Jul. 17, 2007

(30) Foreign Application Priority Data
Jul. 21, 2006 (JP) 2006-199626

(51) Int. Cl. G09G 3/36

(52) U.S. Cl. 345/87; 345/55

(57) ABSTRACT

A circuit for driving a liquid crystal display includes decoders for receiving input data to display, and output amplifiers correspondingly connected to the decoders for selectively driving display cells. In each output amplifier, the gate electrodes of a first transistor forming one input of a differential amplifier and a second transistor larger than the first transistor are selectively connected or disconnected when input data changes logical state. The drain electrodes of a third transistor forming the other input of the differential amplifier and a fourth transistor larger than the third transistor are selectively connected or disconnected when the input data changes logical state. The differential amplifier output is selectively fed back to the second transistor to charge or discharge the second transistor. Delay on the output of the decoders is reduced to thereby minimize delay on the output of the output amplifiers.

### BACKGROUND OF THE INVENTION

1. Field of the Invention

The present invention relates to a drive circuit having a plurality of output amplifiers for outputting drive signals to drive a display panel such as a liquid crystal panel.

2. Description of the Background Art

Recently, a display device such as a liquid crystal display device for displaying moving pictures, etc., has been employed in a video device. Japanese patent laid-open publication No. 230829/1997 discloses an output circuit of a source driver for effectively driving liquid crystal display elements of such a liquid crystal display panel.

To the output amplifiers in such an output circuit, a plurality of decoders are connected, each of which is adapted for selecting one of a plurality of liquid crystal elements by outputting an output signal in response to data and a gamma correction voltage input thereto to the output amplifier. Gamma correction voltage levels are generated by, for example, a resistor array including gamma correction resistors connected in series so as to divide a voltage difference between upper voltage (VGH) and lower voltage (VGL).

However, as the liquid crystal display panel becomes larger in display area and higher in display resolution, it includes more output amplifiers. Further, as the steps of gray scale of the display device increases, the circuit scale of the decoder correspondingly increases. Further, it is required to enhance the accuracy in offset voltage of the output amplifier, which causes the transistors connected to the inputs of the amplifier has to be increased in size, thus resultantly increasing parasitic capacitance on the input of the amplifier so as to delay a signal on the input of the output amplifier to problematically affect a delay on the output signal from the amplifier.

It is therefore an object of the invention to provide a drive circuit having a plurality of output amplifiers with delay on the input thereof minimized, to which the output of a decoder is connected, so as to reduce the delay on the output of the amplifiers.

### SUMMARY OF THE INVENTION

In accordance with the present invention, a drive circuit for driving a display device having a plurality of display cells arranged to form a display screen comprises a plurality of decoders operative in response to input data to be displayed and a gamma correction voltage for outputting output signals so as to select appropriate ones of the display cells; and a plurality of output amplifiers correspondingly connected to the plurality of decoders for amplifying the output signals output from the plurality of decoders to develop drive signals for selectively driving the plurality of display cells on output ports. Each of the plurality of output amplifiers includes a differential amplifier circuit comprising a first transistor having a first size and forming one input port of the differential amplifier, and a second transistor having a second size larger than the first size; a first switch selectively connecting or disconnecting the second transistor to or from the first transistor; and a second switch selectively connecting or disconnecting the output of the output amplifier to or from the second transistor. The first switch is operative in response to a transition of a logical state of the input data to disconnect the second transistor from the first transistor.

According to the invention, the transistors of different sizes are respectively connected to two input ports of a differential amplifier circuit. When the input data changes logical state, the one, larger transistor is disconnected from the other, small-sized transistor and the circuit input port, thereby reducing parasitic capacitance between the decoder and output amplifiers. This will minimize the output delay of the decoders and hence the impact of the delay of the decoders on a signal on the output of the output amplifiers.

### BRIEF DESCRIPTION OF THE DRAWINGS

The objects and features of the present invention will become more apparent from consideration of the following detailed description taken in conjunction with the accompanying drawings in which:

FIG. 1 is a schematic circuit diagram showing a drive circuit of a preferred embodiment according to the invention;

FIG. 2 is a functional block diagram schematically showing an exemplary configuration of an output amplifier of the embodiment shown in FIG. 1;

FIG. 3 is a timing chart useful for understanding the operation of the drive circuit shown in FIG. 1; and

FIG. 4 is a diagram showing an alternative exemplary configuration of the output amplifier.

### DESCRIPTION OF THE PREFERRED EMBODIMENTS

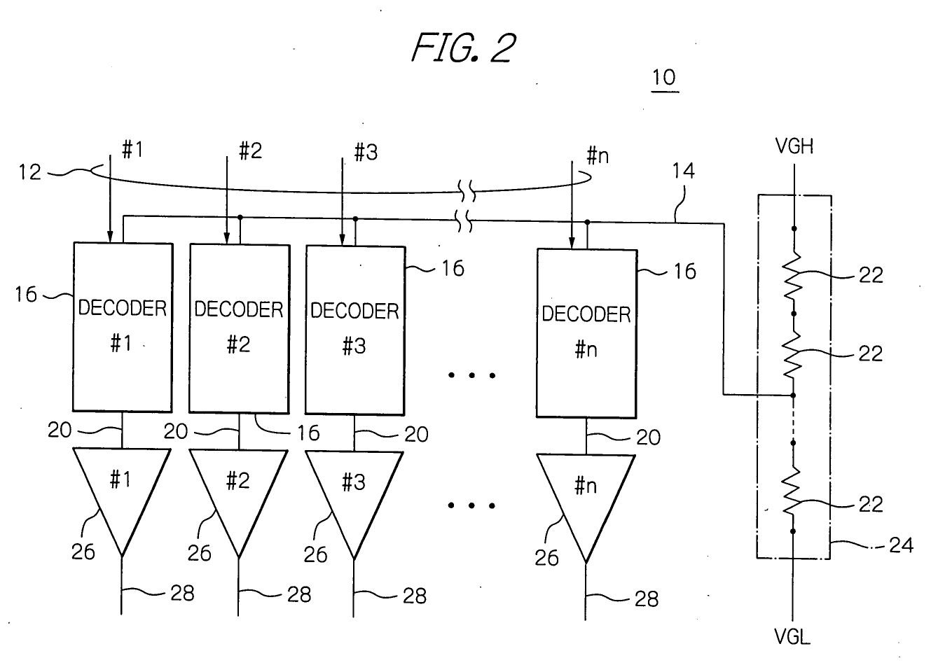

Hereinafter, an embodiment of a drive circuit according to the invention will be described in detail with reference to the accompanying drawings. Referring first to FIG. 2, a drive circuit 10 to which the invention is applied will be described. The drive circuit 10 of the embodiment generates a drive signal for driving a plurality of pixels such as liquid crystal display cells arranged in horizontal and vertical scanning directions to form a bi-dimensional matrix on the display screen of a liquid crystal display panel, not shown, to apply a pixel voltage corresponding to the drive signal to a source signal line of the liquid crystal display panel. Note that in the following, parts or elements not directly pertinent to understanding the invention are omitted from the drawings and description. A display cell such as a liquid crystal display cell is sometimes referred to as a pixel.

The drive circuit 10 of the embodiment includes a plurality of decoders (#1-#n) 16 for comparing data to be displayed, received on input ports (#1-#n) 12, with gamma correction voltages applied to an input port 14 so as to selectively drive a plurality of liquid crystal cells, not shown. Each of the decoders 16 is operative in response to the data 12 and gamma correction voltage 14 to generate a signal for selecting appropriate pixel and output the generated signal on its output line 20 to which the corresponding output amplifier 26 is connected, thereby supplying a pixel voltage to the corresponding liquid crystal cell, not shown, via an output amplifier 26.

The gamma correction voltage levels 14 are generated from a resistor array 24. The resistor array 24 includes a plurality of gamma correction resistors 22 connected in series so as to divide a voltage difference between upper voltage (VGH) and lower voltage (VGL). The gamma correction voltage 14 is applied to the plurality decoders (#1-#n) 16 via a connection line 14. Signals are designated with reference numerals specifying connections on which they appear.

The output amplifiers (#1-#n) 26, connected respectively to the output ports of the decoders 16, is adapted to amplify signals 20 output respectively from the decoders 16 and develop to output lines 28 the drive voltages for driving the liquid crystal cells, not specifically shown.

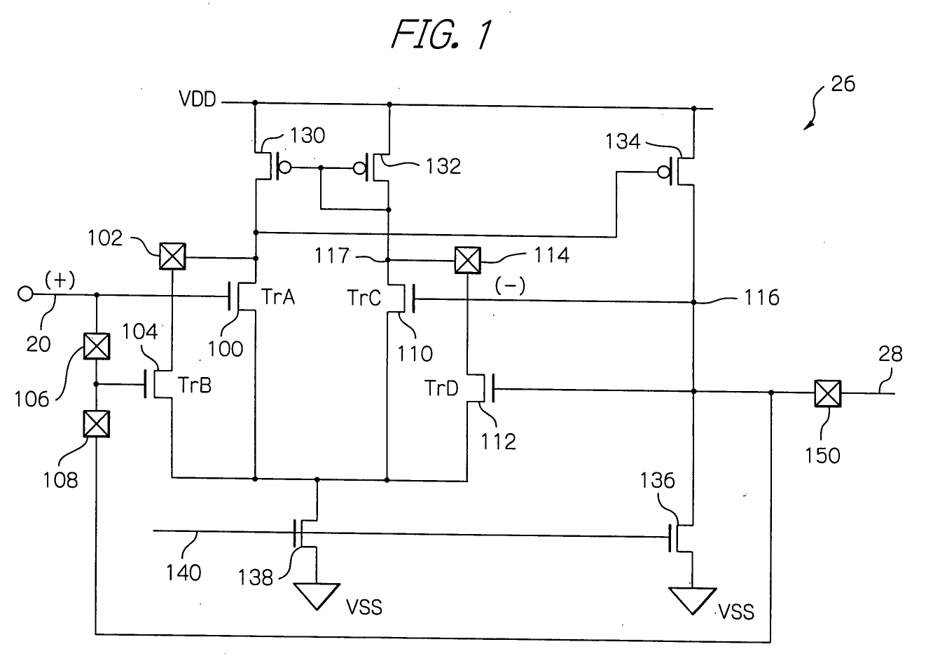

The exemplary internal configuration of the output amplifiers (#1-#n) 26 will be described with reference to FIG. 1. As shown, the output amplifier 26 consists of a differential amplifier circuit having its differential inputs connected to the input 20 and a connection line 116. In particular, with the illustrative embodiment, the differential amplifier circuit includes a MOS (Metal-Oxide Semiconductor) transistor (TrA) 100 which has its gate electrode connected to the positive or non-inverting (+) input 20 and its drain electrode connected in parallel to the drain of another transistor (TrB) 104 via a switch 102. The transistor (TrB) 104 has its gate electrode connected to the amplifier input 20 via another switch 106 and to one terminal of a further switch 108. The switch 108 has its other terminal connected to an amplifier output 28 via a switch 150 with a signal on the connection line 116 fed back to the switch 108. Thus, the latter switch 108 serves as enabling and disabling the application of the fed-back signal.

The size of the transistor (TrA) 100 and transistor (TrB) 104 in the embodiment is defined by the dimensional relationship TrB>>TrA, i.e. the transistor (TrB) 104 is designed to be much larger than the transistor (TrA) 100. In this way, the positive (+) input 20 of the output amplifier 26 is split into two, one for the transistor (TrA) 104 and the other for the transistor (TrB). The split input can establish two connecting conditions, one that only the transistor (TrA) is connected to the input 20 in response to both switches 102 and 106 non-conductive and the other that both transistor (TrA) and transistor (TrB) are connected in parallel with each other in response to both switches 102 and 106 conductive.

The output amplifier 26 further includes a transistor (TrC) 110 constituting a first differential pair with the transistor (TrA) 100 and another transistor (TrD) 112 constituting a second differential pair with the transistor (TrB) 104. The transistor (TrC) 110 and the transistor (TrD) 112 also have the respective drain electrodes thereof connected to each other via a switch 114 and the respective gate electrodes connected to a negative or inverting (−) input terminal 116 of the differential amplifier circuit. The split condition is also implemented with this case such that only the drain electrode of the transistor (TrC) 110 is connected to a connection line 117 in response to the switch 114 non-conductive and the drain electrodes of both transistor (TrC) 110 and transistor (TrD) 112 are connected to the connection line 117 in response to the switch 114 conductive. The transistor (TrD) 112 is designed to be substantially equal in size to the transistor (TrB) 104. Thus, the dimensional relationship TrD=TrB>>TrA is obtained. The transistor (TrC) 110 and transistor (TrA) 100 are substantially equal in size to each other, and the transistor (TrD) 112 and transistor (TrB) 104 are substantially equal in size to each other. Further, as shown, the transistors 100, 104, 110, 112 each are formed of an N-channel MOS transistor.

The transistor (TrA) 100 and transistor (TrC) 110 have the drain electrodes thereof respectively connected to P-channel MOS transistors 130 and 132 acting together as a current source. The P-channel transistors 130 and 132 have their gate electrodes connected to each other and their source electrodes connected to a power supply line VDD. Further, the transistor (TrA) 100 has its drain electrode connected to the gate electrode of another P-channel MOS transistor 134, which is in turn connected between the supply line VDD and connection line 116. The connection line 116 is also connected to the drain electrode of an N-channel transistor 136. The transistors 134 and 136 make up the output stage of this output amplifier 26. Further, the transistors 100, 104, 110 and 112 have the respective source electrodes thereof connected to the drain electrode of an N-channel transistor 138. The transistors 136 and 138 have their gate electrodes connected to a bias line 140 to which a bias voltage is applied, and their source electrodes connected to a supply voltage VSS.

As described above, in the instant embodiment, the first large transistor and first small-sized transistor are disposed on the input side of the input stage of the output amplifier 26, and the second large transistor and second small-sized transistor are disposed on the output side of the input stage. Either one of the large transistor and small-sized transistor is selectable in response to closing and opening of the corresponding switch. Further, the first and second small-sized transistors constituting the first differential pair are formed of the same size and the first and second large transistors constituting the second differential pair are formed of the same size.

The transistor (TrC) 110 and transistor (TrD) 112 have their gate electrodes connected to the other terminal of the switch 108, and the output 116 of the output amplifier 26 is fed back to the gate electrode of the transistor (TrB) 104 when the switch 108 is closed or conductive. Thus, the input capacitance of the gate electrode of the transistor (TrB) 104 can be charged or discharged to a fed-back voltage supplied under the control of the switch 108, when the transistor (TrB) 104 is disconnected by opening or disabling the switch 106. The connection line 116 is connected to the output port 28 via another switch 150.

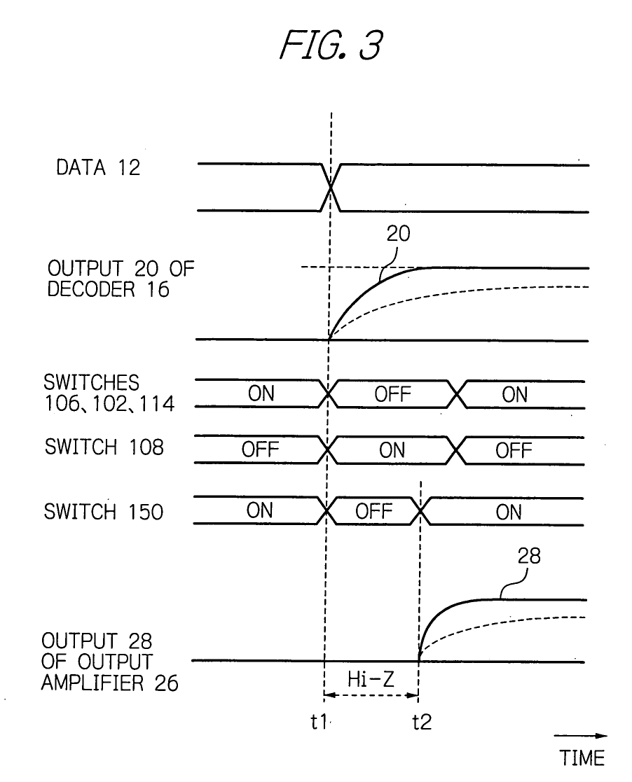

The operation of the drive circuit constructed as described above will be described with reference to FIG. 3. In the initial state, the switches 106, 102 and 114 are on and the switch 108 is off, and the switch 150 is on. Afterwards, when data 12 changes its logical state, the decoder 16 raises its output to the high level (at time t1). At this instant, the switches 106, 102 and 114 are switched from on to off, and the switch 108 is switched to its on position to connect the connection line 116 to the gate electrode of the transistor (TrB) 104, and the switch 150 is switched to its off position. Consequently, the transistor (TrB) 104, thus split out, is disconnected from the input terminal 20 and only the other, remaining transistor (TrA) 100 is still connected to the input terminal 20. Accordingly, an increase in parasitic capacitance compromising the ability of the decoder 16 to charge or discharge the input terminal of the output amplifier 26 is minimized so that the rate at which the input terminal is charged or discharged is increased.

At this instant, the switch 108 is conductive, and thus the gate electrode of the transistor (TrB) 104 is charged or discharged by a signal on the connection line 116 of the output amplifier 26 via the switch 108 (at time t2). Note that during a period from time t1 to time t2, the switch 150 is turned off, thus rendering the output 28 of the amplifier 26 to its high impedance state (Hi-Z).

As described above, the transition of the data 12 causes the switches 102 and 106 to be opened to disconnect the large transistor 104 from the input 20 and the transistor (TrA) 100, and likewise the switch 114 to be opened to disconnect the transistor 112 from the transistor (TrC) 110, thereby reducing parasitic capacitance between the decoder 16 and the output amplifier 26. Accordingly, in the case of a source driver having 10-bit precision and 480 channels, the ratio of reduction in parasitic capacitance therebetween means that the output delay of the decoder 16 is reduced down to about 60% of the output delay, so that the impact of the delay of the decoder 16 on a signal developed over the output 28 of the output amplifier 26 is correspondingly minimized.

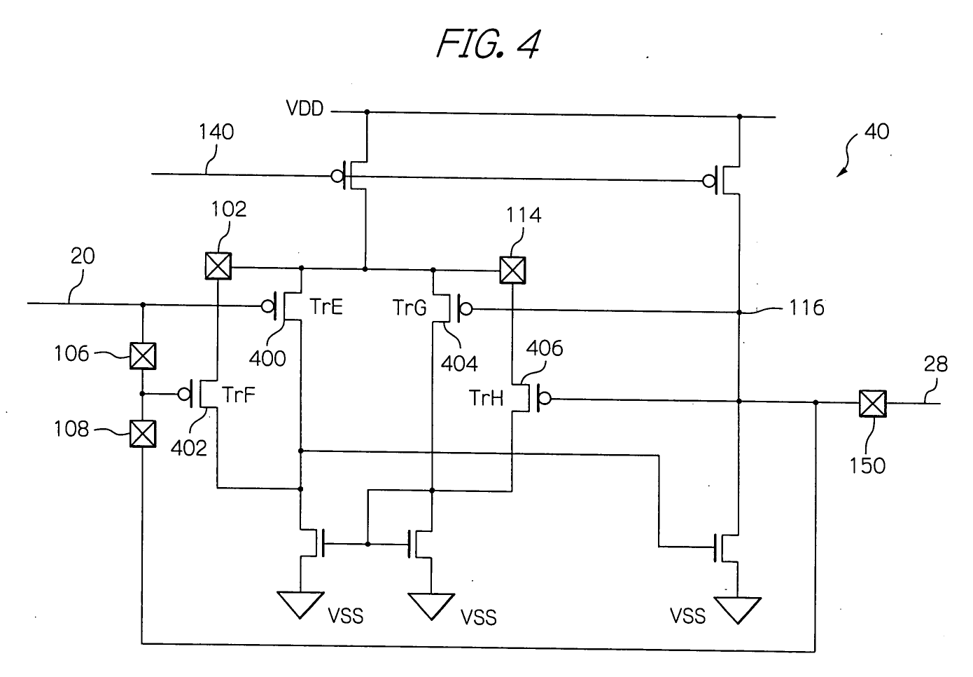

In the above-described embodiment, it is a matter of course that the invention is not limited to an implementation with the N-channel MOS transistor 100 receiving data, but also permits implementation with a P-channel MOS transistor receiving data and constituting the output amplifier 26. An exemplary configuration of an output amplifier having P-channel transistors in an input stage thereof is shown in FIG. 4. As shown in the figure, the output amplifier 40 includes P-channel transistors 400, 402, 404 and 406 in place of the N-channel transistors 100, 104, 110 and 112, respectively, of the output amplifier 26 shown in FIG. 1.

As is the case in the configuration of the output amplifier 26, the FIG. 4 configuration is operative such that the switches 106, 102 and 114 are switched from the conductive state to the cut-off state, the switch 108 is switched to its conductive state, and the switch 150 is switched to its cut-off state. Consequently, only the transistor (TrE) 400, when split, is connected to the input terminal of the output amplifier 40. Accordingly, an increase in parasitic capacitance compromising the ability of the decoder 16 to charge or discharge the input terminal of the amplifier 40 is minimized so that the rate at which the input terminal is charged or discharged is increased. At this instant, the switch 108 is conductive and thus the gate electrode of the transistor (TrB) 402 is charged or discharged by a signal on the connection line 116 of the output amplifier 40 via the switch 108.

The entire disclosure of Japanese patent application No. 2006-199626 filed on Jul. 21, 2006, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A drive circuit for driving a display device having a plurality of display cells arranged to form a display screen, said drive circuit comprising:
a plurality of decoders operative in response to input data to be displayed and a gamma correction voltage for outputting output signals so as to select appropriate ones of the display cells; and
a plurality of output amplifiers correspondingly connected to said plurality of decoders for amplifying the output signals output from said plurality of decoders to develop drive signals for selectively driving the plurality of display cells on output ports,
each of said plurality of output amplifiers including:
a differential amplifier circuit comprising a first transistor having a first size and forming one input port of said differential amplifier, and a second transistor having a second size larger than the first size;
a first switch selectively connecting or disconnecting said second transistor to or from said first transistor; and
a second switch selectively connecting or disconnecting the output of said output amplifier to or from said second transistor,
said first switch being operative in response to a transition of a logical state of the input data to disconnect said second transistor from said first transistor.

2. The drive circuit in accordance with claim 1, wherein said second switch is operative in response to the transition of the logical state of the input data to connect the output port of said output amplifier to said second transistor to cause said second transistor to charge or discharge.

3. The drive circuit in accordance with claim 1, wherein the plurality of display cells are liquid crystal display cells arranged in a bi-dimensional matrix.
